(19) United States
(12) Patent Application Publication
(10) Pub. No.: US 2009/0143915 A1
(43) Pub. Date: Jun. 4, 2009

(54) Environmental control system

(76) Inventors: David S. Dougan, N. Myrtle Beach, SC (US); Michael J. Urbaniak, Little River, SC (US)

Correspondence Address: THOMAS W. EPTING;SMITH MOORE LEATHERWOOD LLP, 300 EAST MCBEE AVENUE, SUITE 500, P.O. BOX 87, GREENVILLE, SC, 29601, US

(21) Appl. No.: 11/999,060

(22) Filed: Dec. 4, 2007

(51) Int. Cl. G05B 21/00; F24F 11/02

(52) U.S. Cl. 700/276; 454/229

(57) ABSTRACT

A system for providing outside air to a space for dilution of contaminants within the space. The system includes an air handler that supplies a flow of outside air to the space and an occupancy detector that calculates the occupancy of people in the space. Also included is a processor that determines a flow rate set point for the outside air for the space based on the occupancy in the space, the floor area of the space, and the flow of outside air supplied by the air handler. An air flow controller is provided that modulates the air flow from the air handler to the space. An open protocol network is connected to the air handler, the occupancy detector, and the air flow controller, and the processor dynamically calculates the outdoor air flow rate set point.

### BACKGROUND OF THE INVENTION

This invention relates generally to an environmental control system for use in connection with a heating, ventilation, and air conditioning (HVAC) system used for a structure or space.

Environmental control of a structure or space may be required for manufacturing, medical, laboratory, agricultural, etc. purposes and also for the comfort and health of occupants which may be in the space. Specifically, in the context of space primarily occupied by people, environmental control is necessary to maintain indoor air quality as may be mandated by applicable codes, regulations, laws, American Society of Heating, Refrigerating and Air Conditioning Engineers (ASHRAE) requirements, etc.

Among the requirements for maintaining proper environmental control, it may be necessary to maintain certain minimums in the supply of outside air to the space, primarily for dilution of contaminates, requiring one or more systems for supplying outside air and for monitoring outside air within the space at a given time.

As the amount of outside air need in the space depends, at least in part, on the number of people in the space, it may also be necessary and/or desirable to have a relatively accurate count of the number of occupants in the space at a given time. Such an occupancy count may entail active and/or passive counting of people, reliance on scheduled occupancies of the space (such as in schools churches, arenas, etc.), detecting people entering and exiting the space and maintaining a running occupancy total, etc. Given such occupancy information and through use of other parameters, the HVAC system and minimum outside air supply requirements modulated accordingly.

Thus, a system for automatically modulating the supply of outside air to a space is desirable, particularly one that is adaptable for use in connection with a variety of HVAC systems.

### SUMMARY OF THE INVENTION

Generally, one preferred embodiment of the present invention includes a system for providing outside air to a space for dilution of contaminants within the space and includes an air handler that supplies a flow of the outside air to the space and an occupancy detector that calculates the approximate occupancy in the space. Also included are means for determining a flow rate set point for the outside air for the space based on the approximate occupancy in the space, the floor area of the space, and the flow of outside air supplied by the air handler.

More specifically, one preferred embodiment of the present invention includes an air flow controller that modulates the air flow from the air handler to the space and an open protocol network connected to the air handler, the occupancy detector, and the air flow controller, and the means for determining said set point dynamically calculates the set point for the outside air flow.

The present invention also includes a method of determining minimum outside air requirements for a space and includes providing an air handler. Outside air is provided to the air handler. The occupancy in the space is determined, and a primary air flow is provided to the space. Using the occupancy, the primary air flow rate, and the floor area of the space, the method includes dynamically determining the minimum outside air requirement for the space.

### BRIEF DESCRIPTION OF THE DRAWINGS

The foregoing, as well as other objects of the present invention, will be further apparent from the following detailed description of the preferred embodiment of the invention, when taken together with the accompanying specification and the drawings, in which:

FIG. 1 is a schematic view of an environmental control system constructed in accordance with the present invention for supplying outside air to a plurality of spaces;

FIG. 2 is a schematic view of an environmental control system constructed in accordance with the present invention for supplying outside air to a space using a direct occupancy count of people in the space;

FIG. 3 is a schematic view of an environmental control system constructed in accordance with the present invention for supplying outside air to a space using outside air carbon dioxide concentration measurements and outside air flow supplied to the space;

FIG. 4 is a schematic view of an environmental control system constructed in accordance with the present invention for supplying outside air to a space using supply air carbon-dioxide measurements taken from air supplied to the space, carbon dioxide measurements taken from the space, and outside air flow supplied to the space; and

FIG. 5 is a schematic view of an environmental control system constructed in accordance with the present invention for supplying outside air to a space using data from a scheduled occupancy of the space.

### DESCRIPTION OF THE PREFERRED EMBODIMENT

The foregoing, as well as other objects of the present invention, will be further apparent from the following detailed description of the preferred embodiment of the invention, when taken together with the accompanying drawings and the description which follows set forth this invention in its preferred embodiment. However, it is contemplated that persons generally familiar with a heating, ventilation, and air conditioning (HVAC) system control will be able to apply the novel characteristics of the structures illustrated and described herein in other contexts by modification of certain details. Accordingly, the drawings and description are not to be taken as restrictive on the scope of this invention, but are to be understood as broad and general teachings.

Referring now to the drawings in detail, wherein like reference characters represent like elements or features throughout the various views, the environmental control system of the present invention is indicated generally in the figures by reference character 10.

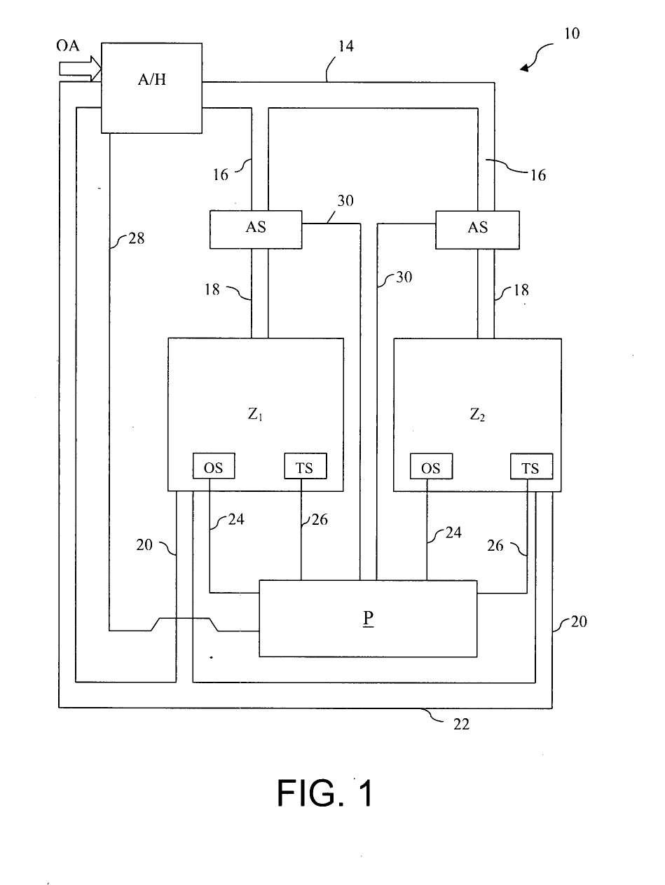

Turning to FIG. 1, the environmental control system, or “system,” 10 of the present invention is shown in use in connection with structures, areas, spaces, supplies, returns, referred to herein generally as “zones”, and in FIG. 1, zones Z₁ and Z₂. Zones Z₁, Z₂ could be spaces used for manufacturing, medical, laboratory, agricultural, etc. purposes and/or spaces primarily for people, such as workplace spaces, offices, schools, classrooms, churches, arenas, restaurants, prisons, retail facilities, etc. The present system could also be used in connection with vehicles, such as automobiles, aircraft, water vessels, trucks, recreational vehicles, etc. Although only two zones Z₁, Z₂ are shown, it is to be understood that the present invention can be used for a single zone, or any number of zones, with the two zones Z₁, Z₂ being shown and discussed herein for illustration purposes only. It is to be further understood that “zones” can also include supply and return plenums, ducts, etc. connected to zones Z₁, Z₂.

Returning to FIG. 1, an air supply device, referred to herein generally as an air handler A/H, is provided. Air handler A/H, which could include a variable speed fan and/or blower (not shown) which can be controlled or modulated, is connected to zones Z₁, Z₂ through supply plenums or ducts, generally 14, through an air flow controller, or air flow sensor, generally AS. Air handler A/H may also include louvers, vanes, valves or the like (none shown) which can be modulated for varying the amount of outside air OA supplied to air handler A/H and conveyed from air handler A/H to supply plenum 14.

Air handler A/H includes an inlet for receiving outside air OA, such outside air OA preferably being ambient air from outdoors, although it is to be understood that outside air OA could also include air from another space or could be a mixture of outdoor air and air from such other space. Generally, however, outside air OA is preferably from outdoors, i.e., from the open air outside of a building or structure.

Air handler A/H receives return air flow from zones Z₁, Z₂ and includes a duct, chamber, and/or compartment (not shown) for allowing the mixing of such return air and outside air OA, such combination then being provided by supply plenum 14 to zones Z₁, Z₂. It is to be understood, however, that such supply air in plenum 14 could be either solely the return air or the outside air OA, and not a combination thereof, if desired.

Air flow controllers AS could be of conventional design and include modulatable air flow control devices, such as vanes, dampers, valves, or the like (none shown), which may be modulated to vary the air flow amount from supply duct 16 to supply duct 18, which feeds air directly into zones Z₁, Z₂. Additional return ducts 20 are provided leading from Z₁, Z₂ to a return plenum 22 and on to air handler A/H.

Provided in each zone Z₁, Z₂ is an occupancy detector or sensor, generally OS, and a temperature sensor, generally TS. The occupancy sensor could be an occupancy sensor such as set forth in co-pending patent application Ser. No. 11/502,639, filed Aug. 11, 2006 and application Ser. No. 11/893,789, filed Aug. 17, 2007, the entirety of both such applications being incorporated herein by reference. In other words, such occupancy sensor could include the use of thermopiles for sensing heat, and in particular, radiant heat of objects and/or people, animals, etc. Circuitry associated with such thermopiles and the electrical current developed by such thermopiles allow for the occupancy of a given space to be approximated. Although not shown, such thermopile arrangements could be positioned adjacent a doorway or other opening into a space and connected (wirelessly and/or through a wired connection 24) to a processor, generally P, which would keep a running total of persons entering and exiting the space, thereby maintaining an approximate occupancy count within such spaces as desired.

In addition to, or instead of, a thermopile sensor, other occupancy detector arrangements could be used for occupancy sensor OS. For example, a turnstile arrangement, carbon dioxide sensors, infrared sensors, and/or motion detectors using the infrared technology or otherwise, could also be used.

Temperature sensors TS, which could be of conventional design, are also connected (wirelessly and/or through a wired connection 26) to processor P for use in making the appropriate calculation in determining the correct amount of outside air OA to be supplied at any given time to zones Z₁, Z₂, respectively.

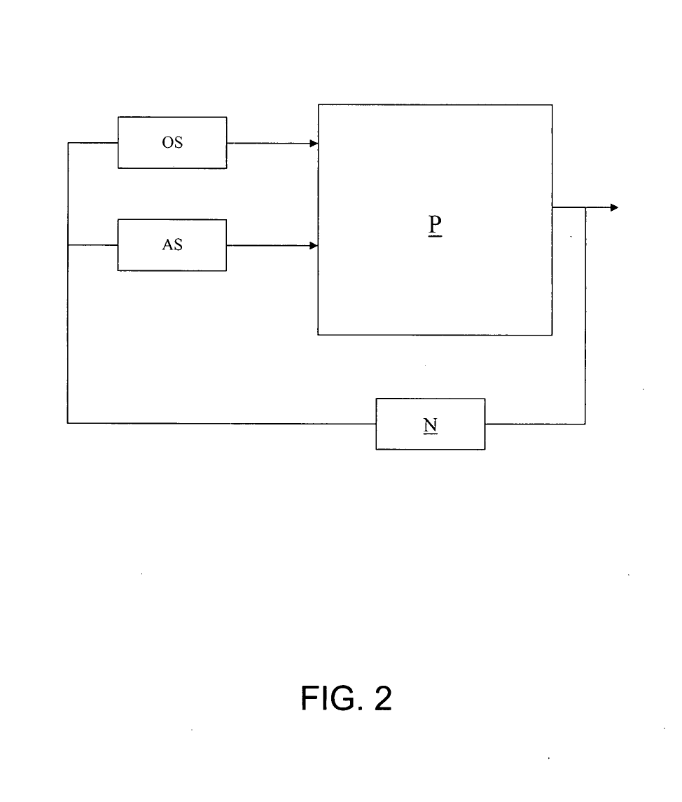

Also connected (wirelessly and/or through wired connections 28, 30) to controller P is air handler A/H and air flow sensors AS, and in communication with processor P provided data to allow for modulation of environmental control system 10 to yield proper outside air OA amounts in the zones Z₁, Z₂. In one preferred embodiment, a communication network N (FIGS. 2 through 5) is used to transfer data between processor P, air handler A/H, air flow sensors AS, occupancy sensors OS, and temperature sensors. Network N can be an open protocol network, a proprietary network, and intranet, an ad hoc network, the Internet, an open network available to compatible devices from various manufacturers, a BACnet MS/TP network and/or some other suitable communications arrangement or network. Network N can, in certain applications, be remotely access through the internet, phone lines, wirelessly, by radio, and/or through optical transmissions. The ability of system 10 to be used on a wide variety of readily available networks, including an open protocol network, and communication schemes potentially allows for increased versatility and robustness in environmental control.

Generally, if the air supply rate to the zone is known, the floor area of the zone is known, and the occupancy of the space is known, the outside air flow intake rate necessary at air handler A/H can be calculated.

FIG. 2 shows a portion of schematic control of an application of environmental control system 10 for supplying outside air OA to one or more zones Z₁, Z₂ using a direct occupancy count of people in each zone. Occupancy sensor OS senses the occupancy in the zone and conveys that information or data to processor P through a wired connection and/or through a wireless connection directly and/or through network N. As discussed above, occupancy sensor OS could be of a number of designs, and could include using data from a turnstile, a light beam detector, a thermopile system, an identification card, retina scan, and/or hand vein sensor, pass code entry system, manual count, etc.

Data from such occupancy sensor OS representing the occupancy in the zone is communicated to processor P together with the floor area, such as square footage, of the zone, and data from air flow sensor AS measuring air flow through a duct 16 (FIG. 1) for use in calculating the minimum outside air flow set point by processor P (using the appropriate algorithms) for the HVAC system, which includes the appropriate modulation instructions being given by processor P to air handler A/H and air flow controller AS directly for modulating air flow. Alternately, air handler A/H and/or air flow controller AS could include a processor and have the capability to modulate themselves independently of or in conjunction with one another and processor P, if desired. Processor P could thus be passive and simply report the status of air handler A/H and air flow controller AS, or could be actively involved in their operation. The minimum outside air flow required for the zone or zones could be determined by ASHRAE Standard 62 and/or other mandatory or voluntary standards, regulations, codes, or the like.

Data from temperature sensor TS is also preferably provided to processor P and can be used in determining set points for air flow.

Air flow sensor AS, as noted above, can have an air flow control function in addition to sensing air flow rates and could include a variable air volume (VAV) device for modulating air flow to the zone. Air flow sensor AS could include a flow sensor device connected to or integral with the VAV device, and such flow sensor device could include a thermal dispersion system, such as manufactured by EBTRON, Inc. of Loris, S.C. USA 29569, and/or could be a pitot device, a pressure sensor, a hot wire or thermal anemometer, a movable vane, manometer, or some other suitable flow measuring device.

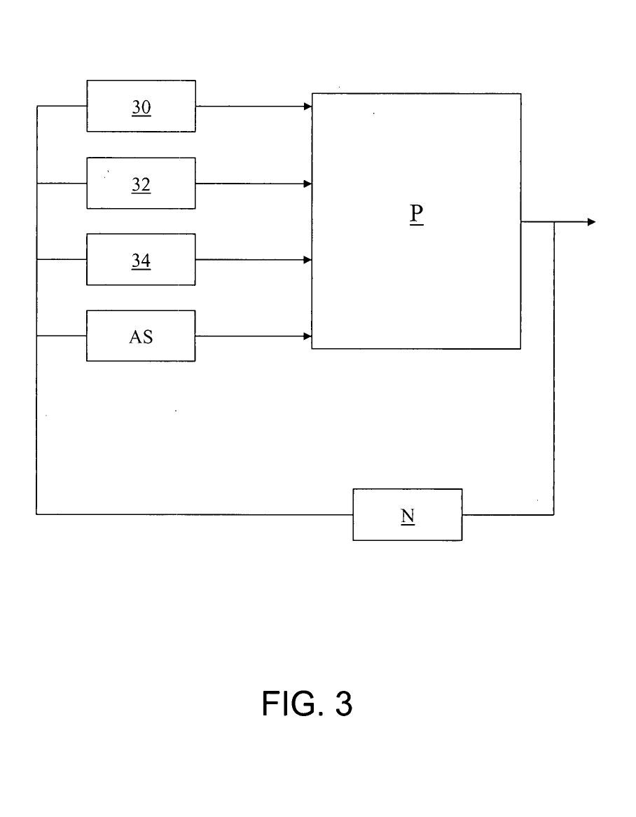

FIG. 3 shows a portion of schematic control of an application of environmental control system 10 for supplying outside air OA to one or more zones Z₁, Z₂ using an indirect occupancy count of people in each zone. Occupancy sensor OS in this application could indirectly determine occupancy based on the carbon dioxide sensed in the space, which correlates through know calculations to an approximation of the occupancy in the space, by virtue of carbon dioxide being exhaled by the occupants in the space. Occupancy sensor OS could also use other passive detection means such as a thermal detection device that detects changes in zone temperature and correlates that to an approximation of occupancy. Occupancy sensor OS could also use a weight based system, in certain applications, having one or more sensors sensing the weight and/or or weight changes on the floor in the zone to approximate occupancy.

A carbon dioxide sensor 30 is provided to sense the carbon dioxide content of the zone. An outside air carbon dioxide sensor 32 may also be provided, if desired, to sense the carbon dioxide content of the incoming outside air OA. Occupancy can be approximated using the data from carbon dioxide sensors 30, 32 and input 34 of the summation of the supply air flow through duct 16 and outside air OA flow rates through air handler A/H. This data together with the air flow through duct 16 as detected by air flow sensor AS can be output to processor P via network N or otherwise and used for calculation of the minimum outside air flow requirement and the minimum outside air flow set point for the HVAC system for the zone or zones. Air handler A/H and/or air flow controller AS could then be modulated as discussed above to maintain the set point for outside air supply to the zone.

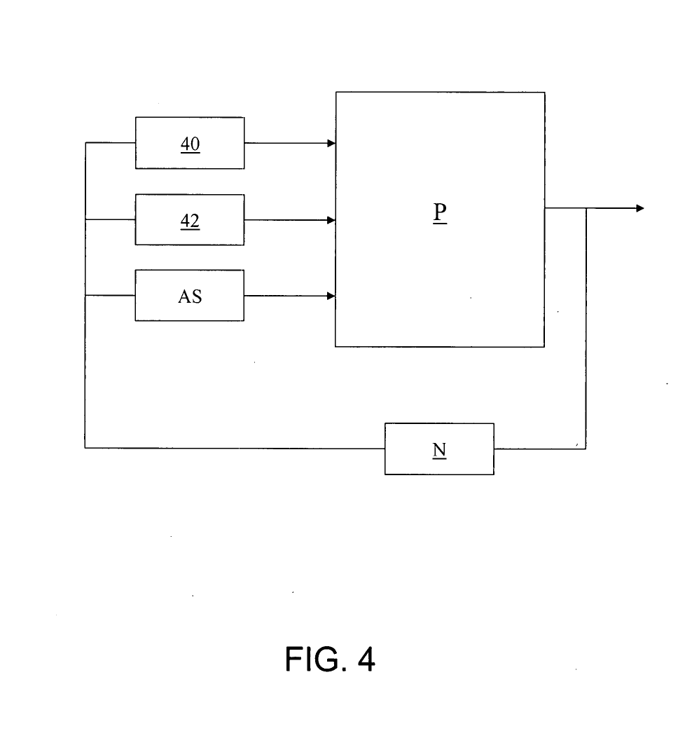

FIG. 4 shows a portion of schematic control of an application of environmental control system 10 for supplying outside air OA to one or more zones also using an indirect occupancy count of people in each zone. Occupancy sensors could be as discussed above regarding the embodiment shown in FIG. 3 for indirectly determining occupancy based on the carbon dioxide sensed in the space. Supply air carbon dioxide sensor 40 is provided for sensing the carbon dioxide in the air supplied to the zone via supply duct 16, and carbon dioxide sensor 42 is provided for sensing the carbon dioxide in the zone and/or return duct 20. Sensor could also be provided in return plenum 22 instead or in addition to return duct 20.

Occupancy, or population, of the space is calculated using the difference in carbon dioxide sensed between supply air carbon dioxide sensor 40 and zone air carbon dioxide sensor 42, such difference being representative of the population in the zone. This data is communicated to processor P via network N or otherwise and is used in connection with the rate of supply air flow as sensed by air flow sensor AS and used for calculation of the targeted or minimum outside air flow requirement and the minimum outside air flow set point for the HVAC system for the zone or zones. Air handler A/H and/or air flow controller AS are modulated as discussed above to maintain the set point for outside air supply to the zone.

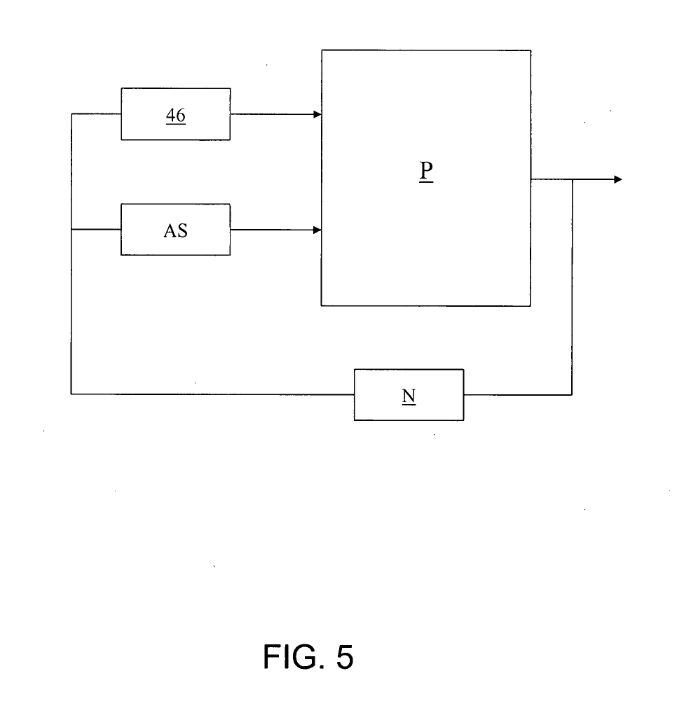

FIG. 5 shows a portion of schematic control of an application of environmental control system 10 for supplying outside air OA to one or more zones also using a scheduled occupancy of people in each zone. Scheduled occupancy could include zones such as class rooms, churches, cafeterias, prisons, dormitories, barracks, hotels, etc. The programmed or schedule occupancy input 46 is thus used in connection with the air flow rate, as sensed by air flow sensor AS, through duct 16 to a zone to for calculation of the minimum outside air flow requirement and the minimum outside air flow set point for the HVAC system for the zone or zones. Air handler A/H and/or air flow controller AS are modulated as discussed above to maintain the set point for outside air supply to the zone. Processor and/or air handler A/H and/or air flow sensor AS could include a clock for applying the scheduled occupancy data from a scheduled occupancy database to control of outside air OA supply to the zone.

In preferred embodiments of the applications discussed above, system 10 calibrates itself in real time, or dynamically, and calculates and recalculates, if necessary, the appropriate outside air OA set points for the zones on a periodic or random basis by using network N to poll one or more of the air handler A/H, air flow sensors AS, occupancy sensors OS, and the other sensors noted above.

With the embodiments discussed above, once the appropriate amount of outside air OA is provided by air handler A/H, such air can then be appropriately conditioned for achieving a target humidity, temperature, etc.

It is to be noted that in the simplest case, i.e., when air handler A/H supplies only one zone Z₁, an air flow sensor AS may not be needed, and in that case the occupancy, floor area and the output rate of air handler A/H is needed for processor P to calculate the minimum outside air flow set point for the HVAC system for the zone. Air handler A/H is modulated accordingly to maintain the set point for outside air supply to the zone. It is also to be noted that for multiple zones, the outside air requirement to each zone supplied by air handler A/H would need to be summed to determine the outside air OA demand required of air handler A/H.

While preferred embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the following claims.

What is claimed is:

1. A method of determining minimum outside air requirements for a space having a floor, the method comprising:
providing an air handler;
providing outside air to said air handler;
determining the occupancy in said space;
providing primary air flow to said space;
determining the primary air flow rate to said space; and
dynamically determining the minimum outside air requirement for the space using said occupancy, said primary air flow rate, and the floor area of the space.

2. A system for providing outside air to a space for dilution of contaminants within the space, the space having a floor, the system comprising:
an air handler that supplies a flow of said outside air to said space;
an occupancy detector that calculates the occupancy in said space; and
a processor that determines an outside air set point for said space based on said occupancy, the floor area of said space, and said flow of outside air supplied by said air handler.

3. The system as defined in claim 2, wherein said processor dynamically calculates said set point for outdoor air flow rate requirement.

4. The system as defined in claim 2, further comprising:
an air flow controller that modulates the air flow from said air handler to said space.

5. The system as defined in claim 2, further comprising:
an air flow controller that modulates the air flow from said air handler to said space;
an open protocol network connected to said processor, said air handler, said occupancy detector, and said air flow controller; and
wherein said processor dynamically calculates said set point.

6. The system as defined in claim 2, wherein said outside air is substantially outdoor air.

7. The system as defined in claim 2, wherein said outside air is a mixture of outdoor air and air from outside of said space.

8. The system as defined in claim 2, further comprising:
said air handler providing supply air to said space;
a flow sensor that measures said flow of said supply air to said space;
a communication network; and
said processor being connected to said air handler, said flow sensor, and said occupancy detector via said communication network.

9. The system as defined in claim 2, further comprising:
said air handler providing supply air to said space;
a flow sensor that measures said flow of said supply air to said space;
a BACnet MS/TP communication network; and
said processor being connected to said air handler, said flow sensor, and said occupancy detector via said BACnet MS/TP communication network.

10. The system as defined in claim 2, further comprising:
said air handler providing supply air to said space;
a flow sensor that measures said flow of said supply air to said space;
an open protocol communication network; and
said processor being connected to said air handler, said flow sensor, and said occupancy detector via said open protocol communication network.

11. The system as defined in claim 2, wherein said occupancy detector includes thermopile sensors.

12. The system as defined in claim 2, wherein said occupancy detector includes a weight sensor connected to said floor of said space.

13. The system as defined in claim 2, further comprising:
said air handler providing supply air to said space;
said occupancy detector including an occupancy carbon dioxide sensor that senses the carbon dioxide level in said space;
a supply air carbon dioxide sensor that senses the carbon dioxide level in said supply air;
a flow sensor that measures said flow of said supply air to said space; and
said processor being connected to said air handler, said flow sensor, and the difference in said carbon dioxide level sensed by said supply air carbon dioxide sensor and said carbon dioxide level sensed by said occupancy carbon dioxide sensor.

14. The system as defined in claim 2, further comprising:
a return air duct that carries return air from said space;
a return air carbon dioxide sensor that senses the carbon dioxide level in said return air;
said occupancy detector including an occupancy carbon dioxide sensor that senses the carbon dioxide level in said space;
a flow sensor that measures said flow of said supply air to said space; and
said processor being connected to said air handler, said flow sensor, and the difference in said carbon dioxide level sensed by said occupancy carbon dioxide sensor and said carbon dioxide level sensed by said return air carbon dioxide sensor.

15. The system as defined in claim 2, further comprising:
said air handler providing supply air to said space;
a flow sensor that measures said flow of said supply air to said space;
a variable air volume unit; and
a thermal dispersion flow sensor substantially integral with said variable air volume unit.

16. The system as defined in claim 2, further comprising:
a variable air volume device connected to said air handler that provides supply air to said space;
said occupancy detector including a thermopile sensor connected to said variable air volume device; and
a thermal dispersion flow sensor connected to said variable air volume device that measures said flow of said supply air to said space.

17. The system as defined in claim 2, further comprising:
a variable air volume device connected to said air handler that provides supply air to said space;
said occupancy detector including a carbon dioxide sensor connected to said variable air volume device; and
a thermal dispersion flow sensor connected to said variable air volume device that measures said flow of said supply air to said space.

18. A system for providing outside air to a space for dilution of contaminants within said space, said space having a floor, the system comprising:
an air handler that supplies a flow of said outside air to said space;
an occupancy detector that calculates the occupancy in said space; and
means for determining a set point for said outside air for said space based on said occupancy, the floor area of said space, and said flow of outside air supplied by said air handler.

19. A system for providing outside air to a space for dilution of contaminants within the space, the space having a floor, the system comprising:
an air handler that supplies a flow of said outside air to said space;
an air flow controller that modulates the air flow from said air handler to said space;
an occupancy detector that calculates the occupancy in said space;
a processor that dynamically determines an outside air set point for said space based on said occupancy, the floor area of said space, and said flow of outside air supplied by said air handler; and
an open protocol network connecting said processor, said air handler, said occupancy detector, and said air flow controller.

20. The system as defined in claim 19, wherein said occupancy detector includes thermopile sensors.

21. The system as defined in claim 19, further comprising:
said air handler providing supply air to said space;
said occupancy detector including an occupancy carbon dioxide sensor that senses the carbon dioxide level in said space;
a supply air carbon dioxide sensor that senses the carbon dioxide level in said supply air; and
said processor being configured to determine the difference in said carbon dioxide level sensed by said supply air carbon dioxide sensor and said carbon dioxide level sensed by said occupancy carbon dioxide sensor.

22. The system as defined in claim 19, further comprising:
a return air duct that carries return air from said space;
a return air carbon dioxide sensor that senses the carbon dioxide level in said return air;
said occupancy detector including an occupancy carbon dioxide sensor that senses the carbon dioxide level in said space; and
said processor being configured to determine the difference in said carbon dioxide level sensed by said occupancy carbon dioxide sensor and said carbon dioxide level sensed by said return air carbon dioxide sensor.

23. The system as defined in claim 19, further comprising:
a variable air volume device connected to said air handler that provides supply air to said space;
said occupancy detector including a thermopile sensor connected to said variable air volume device; and
a thermal dispersion flow sensor connected to said variable air volume device that measures said flow of said supply air to said space.

24. The system as defined in claim 19, further comprising:
a variable air volume device connected to said air handler that provides supply air to said space;
said occupancy detector including a carbon dioxide sensor connected to said variable air volume device;
a thermal dispersion flow sensor connected to said variable air volume device that measures said flow of said supply air to said space.

25. A system for providing outside air to a space for dilution of contaminants within the space, the space having a floor, the system comprising:
means for supplying a flow of said outside air to said space;
means for determining the occupancy in said space based on the concentrations of carbon dioxide in said space;
means for dynamically determining an outside air set point for said space based on said occupancy, the floor area of said space, and said flow of outside air supplied by said air handler; and
an open protocol network connecting said means for supplying a flow of said outside air and said means for determining the occupancy in said space.
